(19) United States
(12) Patent Application Publication
(10) Pub. No.: US 2014/0295139 A1
(43) Pub. Date: Oct. 2, 2014

(54) SURFACE PROTECTION FILM

(71) Applicant: FUJI XEROX CO., LTD., Tokyo (JP)

(72) Inventors: Tomoko MIYAHARA, Kanagawa (JP); Hiroshi SAEGUSA, Kanagawa (JP); Kaoru TORIKOSHI, Kanagawa (JP)

(73) Assignee: FUJI XEROX CO., LTD., Tokyo (JP)

(21) Appl. No.: 13/975,749

(22) Filed: Aug. 26, 2013

(30) Foreign Application Priority Data
Mar. 26, 2013 (JP) 2013-065034

(51) Int. Cl. C08G 18/34; C08K 3/22; C08L 75/04

(52) U.S. Cl. CPC C08G 18/348; C08L 75/04; C08K 3/22
USPC 428/147; 428/141; 428/148

(57) ABSTRACT

A surface protection film contains a urethane resin formed by polymerizing an acrylic resin having a hydroxyl group at a side chain and an isocyanate, and has a Martens' hardness of 50 N/mm² or less and a surface roughness Ra measured based on JIS-B0601 of from 0.05 μm to 1.0 μm.

### CROSS-REFERENCE TO RELATED APPLICATIONS

This application is based on and claims priority under 35 USC 119 from Japanese Patent Application No. 2013-065034 filed Mar. 26, 2013.

### BACKGROUND

1. Technical Field

The present invention relates to a surface protection film.

2. Related Art

Hitherto, a surface protection film has been provided on a surface from the viewpoint of suppressing damage on surfaces in a variety of fields. Examples of use of the surface protection film include protection films for protecting portable terminals, such as smartphones, portable phones and portable game machines; vehicle bodies; vehicle window glass; chassis of personal computers; fixing members, intermediate transferring members and recording medium transporting members in image forming apparatuses; and the like.

### SUMMARY

According to an aspect of the invention, there is provided a surface protection film including a urethane resin formed by polymerizing an acrylic resin having a hydroxyl group at a side chain and an isocyanate, wherein a Martens' hardness is 50 N/mm² or less, and a surface roughness Ra measured based on JIS-B0601 is 0.05 μm to 1.0 μm.

### BRIEF DESCRIPTION OF THE DRAWINGS

Exemplary embodiments of the present invention will be described in detail based on the following figures, wherein:

FIG. 1 is a perspective view illustrating a schematic configuration of an endless belt according to an exemplary embodiment;

FIG. 2 is a cross-sectional view of the endless belt according to the exemplary embodiment;

FIG. 3 is a schematic configuration view illustrating an image forming apparatus in which the endless belt according to the exemplary embodiment is used; and

FIG. 4 is a schematic configuration view illustrating an image fixing apparatus in which the endless belt according to the exemplary embodiment is used.

### DETAILED DESCRIPTION

Hereinafter, an exemplary embodiment of a surface protection film of the invention will be described in detail.

A surface protection film according to the exemplary embodiment contains a urethane resin formed by polymerizing an acrylic resin having a hydroxyl group at a side chain and an isocyanate. The surface protection film has a Martens' hardness of 50 N/mm² or less, and a surface roughness Ra of 0.05 μm to 1.0 μm.

In recent years, touch screens have been in use in a variety of portable terminals such as smartphones, portable phones and portable game machines, and self-repairing materials in which minute damages get repaired as time goes by are attracting attention as protection films. In addition, self-repairing materials also have been in practical use as protection films for vehicle bodies, vehicle window glass; chassis of personal computers; lenses of glasses; recording surfaces of optical discs, such as CDs, DVDs and BDs; solar cell panels or panels that reflect solar light; endless belts or rolls for image forming apparatuses used in fixing members; intermediate transferring members, recording medium transporting members and the like in image forming apparatuses; floors; mirrors; window glass and the like. However, there are cases in which a finger sliding property, dust resistance or the like are required in the above uses.

Here, the fundamental mechanism of self-repairing is that the surface is softened so that, generally, a large load that causes damage is absorbed as recess damage and repaired over time. However, particularly, since a film that repairs damage at room temperature (25° C.) is soft and has a large friction coefficient on the surface, there is a tendency of the surface slipping property to deteriorate. That is, since the friction coefficient is large, dust, sand, specks and the like are easily attached, and further, the wiping property is poor. In addition, there are cases in which dust, specks and the like remain on the surface such that damage of breakage that has failed to be completely repaired becomes easily caused.

In contrast to the above, the surface protection film according to the exemplary embodiment contains a urethane resin formed by polymerizing an acrylic resin having a hydroxyl group at a side chain and an isocyanate, and has a Martens' hardness and a surface roughness Ra in the above ranges.

A surface protection film which contains a urethane resin having the above composition and has a flexibility (that is, Martens' hardness) in the above range also exhibits excellent self-repairing property at room temperature (25° C.), but has a tendency of the slipping property to deteriorate as described above. However, in the exemplary embodiment, since the surface roughness Ra is controlled in the above range, it is possible to exhibit excellent self-repairing property and to achieve excellent surface slipping property.

Surface Roughness Ra

The surface roughness Ra of the surface protection film according to the exemplary embodiment is 0.05 μm to 1.0 μm, more preferably 0.05 μm to 0.5 μm, and still more preferably 0.05 μm to 0.3 μm.

When the surface roughness Ra is less than the lower limit value, excellent surface slipping property may not be obtained. On the other hand, when the surface roughness Ra exceeds the upper limit value, the film is whitened due to light scattering on the film surface, and the transparency is impaired. In addition, in a case in which the film is used in fixing members, intermediate transferring members, recording medium transporting members and the like in image forming apparatuses, there are disadvantages that image qualities deteriorate and the like.

Measurement of the Surface Roughness Ra

Further, the surface roughness Ra of the surface protection film in the exemplary embodiment is measured based on JIS-B 0601 (1994), and, specifically, measured using a surface roughness measuring instrument (SURFCOM 130A manufactured by Tokyo Seimitsu Co., Ltd.). Measurement conditions are, measurement rate: 0.3 mm/sec, cut off value: 0.25 mm, evaluation length: 1.0 mm, filter type: Gaussian and λs filter: cut off ratio of 300. Further, the surface roughness Rz may be obtained using the above method.

Further, a method for controlling the surface roughness Ra of the surface protection film will be described below in detail.

Martens' Hardness

The Martens' hardness of the surface protection film according to the exemplary embodiment is 50 N/mm² or less, more preferably 30 N/mm² or less, and still more preferably 20 N/mm² or less.

In addition, the lower limit value is not particularly limited, but is preferably 0.01 N/mm² or more, more preferably 0.1 N/mm² or more, and still more preferably 0.5 N/mm² or more. When the Martens' hardness exceeds the upper limit value, there is a tendency that sufficient self-repairing property at room temperature (25° C.) may not be obtained.

The Martens' hardness of the surface protection film is adjusted using a method of controlling the number of carbon atoms in the side chain of the acrylic resin having the hydroxyl group, the amount of the side chain having the hydroxyl group, the type of a crosslinking agent (isocyanate) and a ratio of a polyol to the acrylic resin. For example, there is a tendency of the Martens' hardness to be decreased by increasing the amount of the side chain containing the hydroxyl group with a large number of carbon atoms, decreasing the number of functional groups in the crosslinking agent, or decreasing branches of a polymer. On the other hand, there is a tendency of the Martens' hardness to be increased by increasing the number of functional groups in the crosslinking agent, including a structure provided with a steric hindrance or increasing branches of a polymer, and the Martens' hardness may be arbitrarily controlled.

Self-Repairing Property

Here, the self-repairing property refers to a property that repairs strains caused by stresses when the stresses are released.

Further, in the surface protection film according to the exemplary embodiment, as an index of the self-repairing property, a “rate of return” at room temperature (25° C.) which is obtained using the following measurement method is preferably 80% or more. Furthermore, the rate of return is more preferably 85% or more, and becomes more preferable as approaching 100%.

Measurement of the Rate of Return and the Martens' Hardness

A FISCHERSCOPE HM2000 (manufactured by Fischer Technology, Inc.) is used as a measuring apparatus, a sample surface protection film formed by being coated and polymerized on a polyimide film is fixed to a glass slide using an adhesive, and set in the above measuring apparatus. Load is applied to the sample surface protection film at room temperature (25° C.) up to 0.5 mN over 15 seconds, and held at 0.5 mN for 5 seconds. The maximum dislocation at this time is considered to be (h1). After that, the load is released to 0.005 mN over 15 seconds, held at 0.005 mN for 1 minute, and by using a dislocation at this time as (h2), the rate of return [(h1−h2)/h1] is calculated. In addition, the Martens' hardness is obtained from a load dislocation curve at this time.

Method for Controlling the Surface Roughness Ra

Next, a method for controlling the surface roughness Ra of the surface protection film of the exemplary embodiment will be described.

The method for controlling the surface roughness Ra is not particularly limited, and examples thereof include the following methods.

(1) A method of containing a filler in the surface protection film

(2) A method of roughening the surface using a mold having protrusions and recesses

Hereinafter, the above methods will be described in detail.

(1) the Method of Containing a Filler in the Surface Protection Film

A filler is added to and dispersed in a liquid mixture for forming the surface protection film including an acrylic resin, an isocyanate or the like, the solution is coated and heated at a reaction temperature of urethane so as to be cured, thereby forming a surface protection film having filler-caused protrusions and recesses on a surface.

Further, the control of the surface roughness Ra is adjusted by controlling the primary particle diameter, secondary particle diameter, concentration and the like of the filler being added. That is, there is a tendency of the surface roughness Ra to increase as the primary particle diameter increases and the secondary particle diameter increases, and there is a tendency of the surface roughness Ra to increase as the concentration of the filler increases.

Examples of the filler that may be added to the surface protection film include carbon black particles, fluororesin particles (PTFE particles, PFA particles, FEP particles and the like), polyethylene particles, acryl particles, polystyrene particles, urethane particles, polyamide particles, polyimide particles, polyester particles and the like. In addition, the filler is not limited to organic particles, and examples of inorganic particles include particles of metallic oxide such as TiO₂, SiO₂, ZrO₂ and Fe₂O₃; particles of metals such as Au, Ag, Cu and Fe; particles of metallic salts such as BaSO₄; and the like.

Among the above, carbon black particles, PTFE particles, polyethylene particles and silicon oxide particles are preferably used.

Next, the particle diameter of the filler will be described. Further, here, the particle diameter refers to the average particle diameter, that is, the primary particle diameter refers to the “average primary particle diameter” and the secondary particle diameter refers to the “secondary average particle diameter”.

The primary particle diameter of the filler is required to be large to some extent from the viewpoint of controlling the surface roughness Ra as described above, but the self-repairing property improves as the primary particle diameter decreases. The reason for this is not absolutely clear, but is assumed to be because it is considered that, as the primary particle diameter increases, there is a tendency of cracking to easily occur in an interface between the filler and the resin when the film receives an impact, and, conversely, as the primary particle diameter decreases, the occurrence of cracking is suppressed so that sufficient self-repairing property is efficiently exhibited.

Therefore, it is considered to be preferable that the filler have a primary particle diameter set to be small so that the self-repairing property is sufficiently exhibited and particles of the filler be agglomerated so as to have a large secondary particle diameter from the viewpoint of controlling the surface roughness Ra in a target range.

In addition, it is considered that, when the particles of the filler are agglomerated so that the secondary particle diameter becomes large, strains between the agglomerated particles of the filler and the resin that surrounds the strains absorb impacts. It is considered that an improvement of the impact absorption capability suppresses the occurrence of cracking in the interface between the filler agglomerate and the resin, and, furthermore, improves the self-repairing property.

From the above viewpoint, the primary particle diameter of the filler is preferably 0.01 μm to 10 μm, more preferably 0.01 μm to 5 μm, and still more preferably 0.02 μm to 1 μm.

When the primary particle diameter is the upper limit value or less, sufficient self-repairing property may be obtained. In addition, when the primary particle diameter is the lower limit value or more, the surface roughness Ra of the surface protection film is easily controlled in the above range, and excellent surface slipping property may be obtained.

In addition, from the above viewpoint, the secondary particle diameter of the filler is preferably 0.1 μm to 50 μm, more preferably 0.1 μm to 30 μm, and still more preferably 0.3 μm to 5 μm.

When the secondary particle diameter is the lower limit value or more, sufficient self-repairing property may be obtained, the surface roughness Ra of the surface protection film is easily controlled in the above range, and excellent surface slipping property may be obtained. In addition, when the secondary particle diameter is the upper limit value or less, the surface roughness Ra of the surface protection film is easily controlled in the above range, and excellent surface slipping property may be obtained.

Further, the secondary particle diameter of the filler in the surface protection film is adjusted by controlling a method of dispersing the filler in the liquid mixture for forming the surface protection film after addition, the degree of dispersion, dispersion time, a period of time during which the filler is left to stand from dispersion to coating, and the like. That is, as the degree of dispersion is intensified, and the dispersion time is extended, there is a tendency of the secondary particle diameter to be decreased, and, as the period of time during which the filler is left to stand from dispersion to coating is extended, there is a tendency of the secondary particle diameter to increase. In addition, since the secondary particles do not always have a spherical form, the secondary particle diameter described herein refers to a length at which the diameter of the agglomerate becomes the maximum.

Measurement of the Particle Diameter of the Filler

The primary particle diameter and secondary particle diameter of the filler in the exemplary embodiment are measured using a transmission electron microscope (H-9000 manufactured by Hitachi High-Technologies Corporation). Meanwhile, the average particle diameter is the average value of measured particle diameters of 100 particles. Numeric values described in the present specification are obtained from measurement using the above method.

The concentration of the filler included in the surface protection film is preferably 1% by weight to 70% by weight, more preferably 5% by weight to 50% by weight, and still more preferably 10% by weight to 30% by weight with respect to the total solid content in the liquid mixture for forming the surface protection film.

In a case in which the filler is included in the surface protection film, the filler is added and dispersed in addition to the acrylic resin or the isocyanate when preparing the liquid mixture for forming the surface protection film. As an apparatus used for the dispersion, for example, a ball mill, a bead mill, a sand mill, a jet mill, a rotation and revolution-type mixer, an ultrasonic homogenizer, an Ultimaizer, an ultrasonic dispersion apparatus, a HOOVER MULLER or the like is preferably used.

(2) A Method of Roughening the Surface Using a Mold Having Protrusions and Recesses

A mold having a roughened surface corresponding to a desired protrusion and recess pattern is pressed onto a coated film obtained by coating the liquid mixture for forming the surface protection film including the acrylic resin, the isocyanate or the like, and while maintaining this state, the coated film is heated to a reaction temperature of urethane so as to be cured, thereby forming a surface protection film having protrusions and recesses that correspond to the roughened surface on a surface thereof.

In addition, the liquid mixture for forming the surface protection film including the acrylic resin, the isocyanate or the like is coated on a mold having a roughened surface corresponding to a desired protrusion and recess pattern, heated as it is to the reaction temperature of urethane so as to be cured, thereby forming a surface protection film having protrusions and recesses that correspond to the roughened surface on a surface thereof.

The material of the mold is not particularly limited as long as the material may tolerate the heating to the reaction temperature of urethane, and, for example, a metal, a resin or the like is used. Further, a mold release treatment may have been carried out on the roughened surface of the mold, and examples of the mold release treatment include a TEFLON (registered trademark) coating.

Composition of the Liquid Mixture for Forming the Surface Protection Film

Next, the composition of the liquid mixture for forming the surface protection film according to the exemplary embodiment, excluding the filler described above, will be described.

Acrylic Resin

The acrylic resin in the exemplary embodiment has a hydroxyl group at a side chain. When the acrylic resin is manufactured, a monomer having a hydroxyl group is used, and, additionally, a monomer not having a hydroxyl group may be jointly used.

Examples of the monomer having a hydroxyl group include ethylenic monomers having a hydroxyl group such as hydroxymethyl (meth)acrylate, hydroxyethyl (meth)acrylate, hydroxypropyl (meth)acrylate, hydroxybutyl (meth)acrylate and N-methylolacrylamine; and the like.

In addition, the hydroxyl group in the acrylic resin of the exemplary embodiment may be a carboxyl group. Therefore, a monomer having a carboxyl group may be used as the monomer having a hydroxyl group, and specific examples thereof include ethylenic monomers having a carboxyl group such as (meth) acrylic acid, crotonic acid, itaconic acid, fumaric acid, and maleic acid.

Examples of the monomer having no hydroxyl group include ethylenic monomers such as methyl (meth)acrylate, ethyl (meth)acrylate, propyl (meth)acrylate, butyl (meth)acrylate, n-propyl (meth)acrylate, n-butyl (meth)acrylate, isobutyl (meth)acrylate, 2-ethylhexyl (meth)acrylate, n-octyl (meth)acrylate, n-dodexyl (meth)acrylate and other alkyl ester (meth)acrylates.

Further, the method for adjusting the self-repairing property or Martens' hardness of the surface protection film according to the exemplary embodiment is not particularly limited, and examples thereof include the following methods.

(1) The self-repairing property or Martens' hardness of the surface protection film may be arbitrarily adjusted by arbitrarily selecting the content ratio (molar ratio) of side chains having 6 or more carbon atoms (hereinafter referred to as “long side chain hydroxyl group”) to all side chains having the hydroxyl group in the acrylic resin.

(2) The self-repairing property or Martens' hardness of the surface protection film may be arbitrarily adjusted by, when synthesizing a urethane resin, further adding polyols having plural hydroxyl groups in addition to the acrylic resin having a hydroxyl group at a side chain and an isocyanate, and arbitrarily selecting the number of carbon atoms in the polyol and the addition ratio (molar ratio) of the polyols to the acrylic resin.

In the exemplary embodiment, the ratio (molar ratio) of the long side chain hydroxyl groups to all the side chains having a hydroxyl group is preferably adjusted from the viewpoint of adjusting the self-repairing property or Martens' hardness of the surface protection film in the above ranges. For example, the ratio (molar ratio) of the long side chain hydroxyl groups is preferably 40 mol % or more, more preferably 45 mol % or more, still more preferably more than 75 mol %, still more preferably 85 mol % or more, and may be 100 mol %.

Further, the number of carbon atoms in the long side chain hydroxyl group is 6 or more as described above, for example, 6 to 60, and may be 10 to 30.

Examples of a monomer that becomes the long side chain hydroxyl group include monomers obtained by adding ε-caprolactone or a diol compound having 6 or more carbon atoms to the above monomers having a hydroxyl group or the above monomers having a carboxyl group, and the like.

Specific examples include monomers obtained by adding ε-caprolactone in a range of 1 mole to 10 mole to 1 mole of hydroxymethyl (meth)acrylate; monomers obtained by adding hexanediol, heptanediol, octanediol, nonanediol or decanediol to hydroxymethyl (meth)acrylate, and the like.

Regarding the monomer that becomes the long side chain hydroxyl group, only one monomer may be used, or two or more monomers may be used, but acrylic resins having similar side chain lengths may be easily obtained when only one monomer is used.

In a case in which the acrylic resin has two or more long side chain hydroxyl groups with mutually different numbers of carbon atoms, the difference in the number of carbon atoms between the number of carbon atoms in the long side chain hydroxyl group having the largest number of carbon atoms and the number of carbon atoms in the long side chain hydroxyl group having the smallest number of carbon atoms is, for example, 10 or less, and may be 6 or less.

In addition, the acrylic resin may contain a fluorine atom, and, when monomers having a fluorine atom are jointly used and polymerized, the fluorine atoms are included in the acrylic resin.

The number of carbon atoms in the side chain in a constituent unit derived from the monomer having a fluorine atom is preferably 2 to 20, and more preferably 2 to 10. In addition, a carbon chain in the side chain in the constituent unit derived from the monomer having a fluorine atom may have a linear shape or a branched shape. The number of fluorine atoms included in a molecule of the monomer having a fluorine atom is not particularly limited, and examples thereof include 1 to 25, and may be 9 to 17.

Specific examples of the monomer having a fluorine atom include 2-(perfluorobutyl)ethyl acrylate, 2-(perfluorohexyl)ethyl acrylate, 2-(perfluorohexyl)ethyl methacrylate, perfluorohexyl ethylene and the like.

The addition ratio of the monomer having a fluorine atom to all monomers that configure the acrylic resin is preferably 0.1% by weight to 50% by weight, more preferably 1% by weight to 25% by weight, and more preferably 1% by weight to 10% by weight.

In addition, the acrylic resin may contain a silicone chain, and, when monomers having a silicone chain are jointly used and polymerized, an acrylic resin having a silicone chain at a side chain as illustrated in the following formula (1) is formed.

Further, the acrylic resin illustrated in the formula (1) may be used instead of a silicone described below, and may be jointly used with the silicone described below.

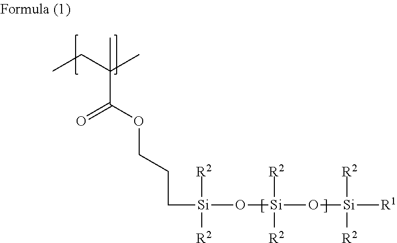

In the formula (1), R¹ represents an amino group, a hydroxyl group, a methoxy group or an ethoxy group, and R² represents a methyl group, a phenyl group or an ethyl group. Further, the number (n) of groups in the parenthesis in —[Si(R²)₂—O]— in the formula (1) is not particularly limited, but is preferably 3 to 1,000.

The molecular weight (weight-average molecular weight) of a silicone monomer used in polymerization of an acrylic resin having a silicone chain is preferably 250 to 50,000, and more preferably 500 to 20,000.

Specific examples of the silicone monomer used in polymerization of the acrylic resin having a silicone chain include SILAPLANE FM-0771, FM-0721, FM-0725 (manufactured by Chisso Corporation) and the like.

Examples of a method for synthesizing the acrylic resin include a method in which the above monomers having a hydroxyl group or the above monomers and another monomer that may be jointly used are mixed, radically or ionically polymerized, and then purified.

The hydroxyl value of the acrylic resin is preferably 50 mgKOH/g to 400 mgKOH/g, more preferably 70 mgKOH/g to 400 mgKOH/g, and still more preferably 100 mgKOH/g to 350 mgKOH/g.

Further, the hydroxyl value represents the mg number of potassium hydroxide necessary to acetylate hydroxyl groups in 1 g of a specimen. The hydroxyl value in the exemplary embodiment is measured in accordance with a method specified in JIS K 0070-1992 (potentiometric titration). However, in a case in which a sample is not dissolved, a solvent such as dioxane or THF is used.

In the surface protection film according to the exemplary embodiment, only one acrylic resin may be used, or two or more acrylic resins may be jointly used.

Polyol

In addition, when synthesizing a urethane resin in the exemplary embodiment, a polyol having plural hydroxyl groups may be further added as a chain extender in addition to the acrylic resin having a hydroxyl group at the side chain and an isocyanate.

Further, the self-repairing property or Martens' hardness of the surface protection film may be arbitrarily adjusted by arbitrarily selecting the number of carbon atoms in the polyol, the addition ratio (molar ratio) of the polyols to the acrylic resin and the like at this time.

A polyol used as the chain extender is preferably a polyol in which all hydroxyl groups are linked by chains having 6 or more carbon atoms (hereinafter referred to simply as “long chain polyol”).

In addition, the polyol is preferably a polyol polymerized at a polymerization ratio at which a ratio (B/A) of a total molar amount (B) of hydroxyl groups included in all polyols used for polymerization of the urethane resin to a total molar amount (A) of hydroxyl groups included in all the acrylic resins used for the polymerization becomes 0.1 to 10.

Furthermore, in a case in which a polyol is added as the chain extender, an acrylic resin having a content ratio (molar ratio) of the long side chain hydroxyl group to a short side chain hydroxyl group of less than ⅓ (including acrylic resins not having the long side chain hydroxyl group) is preferably applied as the acrylic resin.

The long chain polyol (polyol having plural hydroxyl groups that are all linked by chains with 6 or more carbon atoms (the number of carbon atoms in a portion of a linear chain that links the hydroxyl groups)) is not particularly limited, and examples thereof include difunctional polycaprolactone diols such as compounds represented by the following structural formula (1), trifunctional polycaprolactone triols such as compounds represented by the following structural formula (2), additionally, tetrafunctional polycaprolactone polyols, and the like. The number of the long chain polyols may be one or two or more.

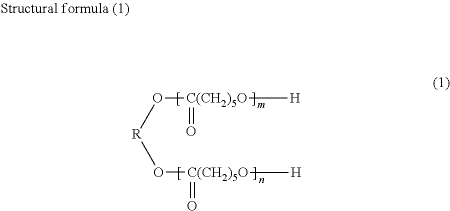

In the structural formula (1), R represents any one of C₂H₄, C₂H₄OC₂H₄ and C(CH₃)₂ (CH₂)₂, and m and n represent an integer of 4 to 35.

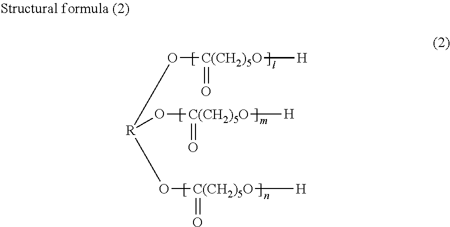

In the structural formula (2), R represents any one of CH₂CHCH₂, CH₃C(CH₂)₂ and CH₃CH₂C(CH₂)₃, and (1+m+n) represents an integer of 3 to 30.

In addition, the polyol may contain a fluorine atom. Examples of the polyol containing a fluorine atom include 1H,1H,9H,9H-perfluoro-1,9-nonanediol, fluorinated tetraethylene glycol, 1H,1H,8H,8H-perfluoro-1,8-octanediol and the like.

Regarding the contents of the polyol containing a fluorine atom, the polyol is blended so that the ratio (B/A) of the total molar amount (B) of hydroxyl groups included in all the polyols (all of polyols containing a fluorine atom and polyols not containing a fluorine atom) used for the polymerization to the total molar amount (A) of hydroxyl groups included in all the acrylic resins used for the polymerization becomes 0.1 to 10.

The polyol preferably has 2 to 5 functional groups, and more preferably has 2 to 3 functional groups.

Further, the ratio (B/A) of the total molar amount (B) of hydroxyl groups included in all the polyols used for the polymerization to the total molar amount (A) of hydroxyl groups included in all the acrylic resins used for the polymerization is preferably 0.1 to 10, and more preferably 1 to 4.

When the ratio is 0.1 to 10, more excellent damage resistance is obtained.

Silicone

When forming the surface protection film according to the exemplary embodiment, in addition to the acrylic resin or the isocyanate, a silicone may be further polymerized. Further, the silicone is preferably at least one silicone selected from compounds represented by the following formula (2).

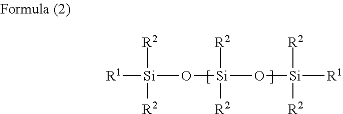

In the formula (2), R¹ represents an amino group, a hydroxyl group, a methoxy group or an ethoxy group, and R² represents a methyl group, a phenyl group or an ethyl group. Further, the number (n) of groups in the parenthesis in —[Si(R²)₂—O]— in the formula (2) is not particularly limited, but is preferably 3 to 1,000.

In addition, instead of the silicone, at least one acrylic resin selected from the compounds represented by the formula (1) having a silicone chain at a side chain may be used.

R¹s in the formulae (1) and (2) represent amino groups, hydroxyl groups, methoxy groups or ethoxy groups, and among the above, are more preferably hydroxyl groups or methoxy groups.

R² represents a methyl group, a phenyl group or an ethyl group, and, among the above, is more preferably a methyl group or a phenyl group.

The molecular weight (weight-average molecular weight) of the silicone represented by the formula (2) is preferably 250 to 50,000, and more preferably 500 to 20,000.

Specific examples of the silicone represented by the formula (2) include KF9701, KF8008, KF6001 (manufactured by Shin-Etsu Chemical Co., Ltd.), TSR160, TSR145, TSR165, YF3804 (manufactured by Momentive Performance Materials Japan Inc.) and the like.

Further, when forming the surface protection film according to the exemplary embodiment, in a case in which the acrylic resin having a silicone chain is used or the silicone is used, a weight ratio of monomers having the silicone chain (Si—O) to all monomers used for the polymerization of the urethane resin is preferably 1% by weight to 50% by weight, and more preferably 5% by weight to 40% by weight.

The weight ratio mentioned herein represents, for example, in a case in which the urethane resin is formed by polymerizing the acrylic resin not having a silicone chain (a), a silicone (b) and an isocyanate (c), a weight ratio of monomers of the silicone (b) to all monomers. In addition, in a case in which the urethane resin is formed by polymerizing the acrylic resin having a silicone chain (a′) and the isocyanate (c), the weight ratio represents a weight ratio of monomers having a silicone chain (Si—O) of monomers used for synthesis of the acrylic resin (a′) to all monomers. Furthermore, in a case in which the urethane resin is formed by polymerizing the acrylic resin having a silicone chain (a′), the silicone (b), and the isocyanate (c), the weight ratio represents a weight ratio of monomers of the silicone (b) and monomers having a silicone chain (Si—O) of monomers used for the synthesis of the acrylic resin (a′) to all monomers.

Isocyanate

The isocyanate that configures the urethane resin functions as a crosslinking agent that crosslinks the acrylic resins, the acrylic resin and the silicone, and the silicones. In addition, the isocyanate also functions as a crosslinking agent that crosslinks the acrylic resin and the polyol, the polyol and the silicone, and the polyols.

The isocyanate is not particularly limited, and examples thereof that may be preferably used include diisocyanates such as methylene diisocyanate, toluene diisocyanate, hexamethylene diisocyanate and isophorone diisocyanate. In addition, an isocyanuarate-type polyfunctional isocyanate, a burette-type polyfunctional isocyanate, an adduct-type polyfunctional isocyanate or the like, which are multimeric complexes of hexamethylene diisocyanate, may be used. The number of the isocyanate may be one or two or more. Furthermore, an isocyanate having functional groups blocked so as not to react until a specific temperature may be used.

Further, regarding the addition amount of the isocyanate, the molar number of isocyanate groups being added is preferably in a range of 0.5 time to 3 times a total molar number ((b)+(e)+(f)) of a molar number (d) of the hydroxyl group in the acrylic resin, a molar number (e) of the hydroxyl group in the silicone and a molar number (f) of the hydroxyl group in the polyol.
Polymerization method

Next, a method for forming the surface protection film according to the exemplary embodiment (method for polymerizing a resin) will be described.

As an example, a method for forming a sample will be described. The acrylic resin, the isocyanate, and when further added, the silicone, the polyol, the filler and the like are mixed, defoamed under reduced pressure, then, cast on a polyimide film so as to form a sample resin layer, and the sample resin layer is heated and cured (for example, for 60 minutes at 85° C., 30 minutes for 130° C.), thereby forming a surface protection film. Further, when practically used, the surface protection film is coated on a surface to be protected, heated and cured in the same manner.

Further, the self-repairing property of the surface protection film is adjusted using a method of controlling the amount or the number of the functional groups of the silicone, the amount or the number of carbon atoms of the long side chain hydroxyl group in the acrylic resin, the amount or the number of carbon atoms of side chains having less than 6 carbon atoms (short side chain hydroxyl group), the amount of the silicone chain in the acrylic resin, the amount or the number of carbon atoms of the polyol, the hydroxyl value of the acrylic resin, the type and amount of the crosslinking agent (isocyanate), and the like, or a method of adjusting crosslinking efficiency to control crosslinking density.

The thickness of the surface protection film is not particularly limited, but preferably 1 μm to 500 μm, and more preferably 10 μm to 50 μm.

Use

The surface protection film according to the exemplary embodiment, which is obtained in the above manner, may be used with no particular limitation as long as a film may be scratched on a surface due to contact with foreign materials. Examples of the film that may be scratched due to contact with foreign materials when coming into contact with the foreign materials on a surface include films for portable terminals such as smartphones, portable phones and portable game machines, window glass, eyeglass lenses, vehicle window glass or vehicle bodies, chassis of personal computers, recording surfaces of optical discs, such as CDs, DVDs and BDs; solar cell panels or panels that reflect solar light; endless belts or rolls for image forming apparatuses used in fixing members; intermediate transferring members, recording medium transporting members and the like in image forming apparatuses; floors; mirrors and the like.

In portable terminals such as smartphones, portable phones and portable game machines, there are cases in which screens are scratched when fingertips (nails) or stylus tips come into contact with and rub the screens.

In addition, since there is exposure to outside environment, there are cases in which window glass, vehicle window glass, vehicle bodies and the like are scratched due to a variety of causes such as contact with sand, leaves, tree branches and the like conveyed by wind or contact with insects and the like.

In addition, in eyeglass lenses or the like, there are cases in which minute particles (contaminations) are attached to a surface, and the surface is rubbed using dry cloths with the minute particles thereon so as to be scratched.

In addition, in recording surfaces of optical discs, such as CDs, DVDs and BDs, and the like, there are cases in which the recording surfaces are brought into contact with case edges when put into and out of a case, brought into contact with apparatus edges when put into and out of a reproduction apparatus, a recording apparatus or the like, or brought into contact with fingertips (nails), and friction with the edges and fingertips causes scratches on the recording surfaces.

In addition, since there is exposure to outside environment, there are cases in which solar cell panels or panels that reflect solar light are scratched due to a variety of causes such as contact with sand, leaves, tree branches and the like conveyed by wind or contact with insects and the like.

In addition, since brought into contact with recording media such as paper or other members in image forming apparatuses, there are cases in which endless belts or rolls for image forming apparatuses used in fixing members, intermediate transferring members, recording medium transporting members and the like in image forming apparatuses are scratched due to friction with recording media or other members.

In addition, aspects are not limited to what has been described above, and, as long as an object has a surface that comes into contact with foreign substances, there are cases in which friction with the foreign substances causes scratches on the surfaces.

When the surface protection film according to the exemplary embodiment is provided on a surface of an object that comes into contact with foreign substances, damage caused by contact with the foreign substances is efficiently repaired.

Endless Belt

An endless belt for an image forming apparatus according to the exemplary embodiment includes a belt-shaped base material and the surface protection film according to the exemplary embodiment provided on the belt-shaped base material.

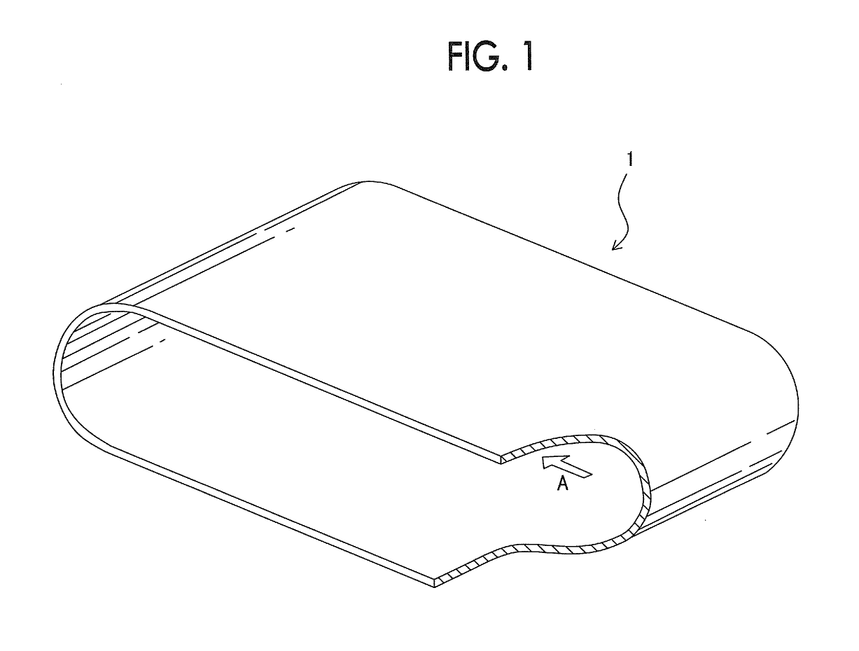

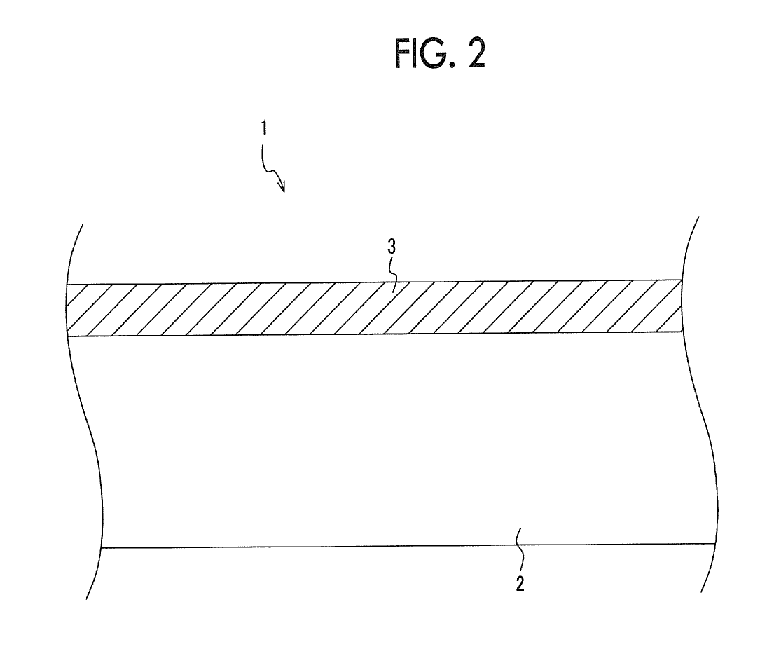

FIG. 1 is a perspective view (partially illustrated using a cross-section) illustrating the endless belt according to the exemplary embodiment, and FIG. 2 is a cross-sectional view of the endless belt seen from an arrow A direction in FIG. 1.

As illustrated in FIGS. 1 and 2, the endless belt 1 of the exemplary embodiment is an endless-shaped belt having a base material 2 and a surface layer 3 laminated on a surface of the base material 2.

Further, the surface protection film according to the exemplary embodiment is applied as the surface layer 3.

The endless belt 1 is used for, for example, fixing belts, intermediate transferring belts, recording medium transporting belts and the like in image forming apparatuses.

Hereinafter, a case in which the endless belt 1 is used as a fixing belt will be described.

A material used for the base material 2 is preferably a heat-resistant material, and, specifically, a material selected from a variety of well-known plastic materials and metal materials is used.

Among plastic materials, a material generally known as engineering plastic is preferable, and preferable examples thereof include fluororesin, polyimides (PI), polyamide-imides (PAI), polybenzimidazoles (PHI), polyether ether ketones (PEEK), polysulfones (PSU), polyether sulfones (PES), polyphenylene sulfides (PPS), polyether imides (PEI), wholly aromatic polyesters (liquid crystalline polymers) and the like. In addition, among the above, thermosetting polyimides, thermoplastic polyimides, polyamide-imides, polyether imides, fluororesins, all of which are excellent in terms of mechanical strength, heat resistance, abrasion resistance, chemical resistance and the like, are preferable.

In addition, the metal material used for the base material 2 is not particularly limited, a variety of metal or alloy materials are used, and, for example, SUS, nickel, copper, aluminum, iron and the like are preferably used. In addition, the heat-resistant resin or the metal material may be laminated into plural layers.

Hereinafter, a case in which the endless belt 1 is used as an intermediate transferring belt or a recording medium transporting belt will be described.

Examples of the material used for the base material 2 include polyimide-based resins, polyamide-imide-based resins, polyester-based resins, polyamide-based resins, fluororesin-based resins and the like, and, among the above, polyimide-based resins and polyamide-imide-based resins are more preferably used. Meanwhile, the base material may or may not have a joint as long as the base material has a circular shape (endless shape), and, generally, the thickness of the base material 2 is preferably 0.02 mm to 0.2 mm.

In a case in which the endless belt 1 is used as an intermediate transferring belt or a recording medium transporting belt of an image forming apparatus, the surface resistivity is preferably controlled in a range of 1×10⁹Ω/□ to 1×10¹⁴Ω/□, and the volume resistivity is preferably controlled in a range of 1×10⁸ Ωcm to 1×10¹³ Ωcm. Therefore, as described above, carbon black such as Ketjen Black or acetylene black; a metal or an alloy such as graphite, aluminum, nickel or a copper alloy; a metal oxide such as tin oxide, zinc oxide, potassium titanate or a complex oxide of tin oxide-indium oxide or tin oxide-antimony oxide; a conductive polymer such as polyaniline, polypyrrol, polysulfone or polyacetylene; or the like is preferably added to the base material 2 or the surface layer 3 as a conducting agent (here, the polymer being “conductive” means that the polymer has a volume resistivity of less than 10⁷ Ω·cm.). The conducting agent is used alone, or two or more conducting agents are jointly used.

Here, the surface resistivity and the volume resistivity are measured using a Hiresta-UP MCP-HT450 UR probe manufactured by Mitsubishi Chemical Analytech under environments of 22° C. and 55% RH in accordance with JIS-K 6911.

In the case of a fixing use, the endless belt 1 may include an elastic layer between the base material 2 and the surface layer 3. As a material for the elastic layer, a variety of rubber materials are used. Examples of the variety of rubber materials include urethane rubber, ethylene propylene rubber (EPM), silicone rubber, fluorine rubber (FKM) and the like, and silicone rubber that is excellent in terms of heat resistance and workability is particularly preferable. Examples of the silicone rubber include RTV silicone rubber, HTV silicone rubber and the like, and specific examples include polydimethyl silicone rubber (MQ), methyl vinyl silicone rubber (VMQ), methyl phenyl silicone rubber (PMQ), fluorosilicone rubber (FVMQ) and the like.

In a case in which the endless belt 1 is used as a fixing belt in an electromagnetic induction-type fixing apparatus, a heat-generating layer may be provided between the base material 2 and the surface layer 3.

Examples of a material used for the heat-generating layer include non-magnetic metals, and specific examples include metal materials such as gold, silver, copper, aluminum, zinc, tin, lead, bismuth, beryllium, antimony, alloys thereof (alloys including the above) and the like.

The film thickness of the heat-generating layer is preferably set in a range of 5 μm to 20 μm, more preferably set in a range of 7 μm to 15 μm, and particularly preferably set in a range of 8 μm to 12 μm.

Roll

A roll for an image forming apparatus according to the exemplary embodiment includes a cylindrical base material and the surface protection film according to the exemplary embodiment provided on the cylindrical base material.

Next, the roll according to the exemplary embodiment will be described. The roll of the exemplary embodiment is a cylindrical roll having a base material and a surface layer laminated on a surface of the base material.

Further, the surface protection film according to the exemplary embodiment is applied as the surface layer.

The cylindrical roll is used for, for example, fixing rolls, intermediate transferring rolls, recording medium transporting rolls and the like in image forming apparatuses.

Hereinafter, a case in which the cylindrical roll is used as a fixing roll will be described.

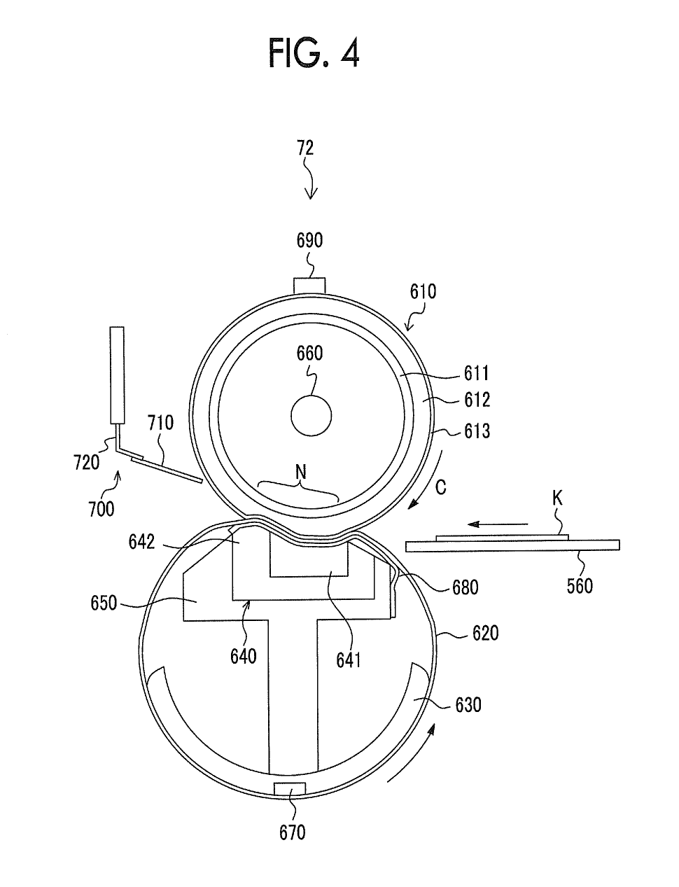

A fixing roll 610 as a fixing member illustrated in FIG. 4 has no particular limitation in the shape, structure, size and the like, and includes a surface layer 613 on a cylindrical core 611. In addition, as illustrated in FIG. 4, an elastic layer 612 may be provided between the core 611 and the surface layer 613.

Examples of a material for the cylindrical core 611 include metals such as aluminum (for example, A-5052 material), SUS, iron and copper, alloys, ceramics, FRM and the like. A fixing apparatus 72 of the exemplary embodiment is configured of a cylindrical member having an outer diameter φ of 25 mm, a thickness of 0.5 mm and a length of 360 mm.

A material for the elastic layer 612 is selected from well-known materials, and any material may be used as long as the material is a highly heat-resistant elastic member. Particularly, an elastic member such as rubber having a rubber hardness of approximately 15° to 45° (JIS-A) or elastomer is preferably used, and examples thereof include silicone rubber, fluorine rubber and the like.

In the exemplary embodiment, among the above materials, silicone rubber is preferable due to a small surface tension and excellent elasticity. Examples of the silicone rubber include RTV silicone rubber, HTV silicone rubber and the like, and specific examples include polydimethyl silicone rubber (MQ), methyl vinyl silicone rubber (VMQ), methyl phenyl silicone rubber (PMQ), fluorosilicone rubber (FVMQ) and the like.

Meanwhile, the thickness of the elastic layer 612 is preferably 3 mm or less, and more preferably in a range of 0.5 mm to 1.5 mm. In the fixing apparatus 72, HTV silicone rubber having a rubber hardness of 35° (JIS-A) is coated on the core at a thickness of 72 μm.

The thickness of the surface layer 613 is, for example, 5 μm to 50 μm, and may be 10 μm to 30 μm.

As a heating source that heats the fixing roll 610, for example, a halogen lamp 660 is used. The halogen lamp is not particularly limited as long as the lamp has a shape and a structure that can be stored in the core 611, and is selected depending on purpose. The surface temperature of the fixing roll 610 heated using a halogen lamp 660 is measured using a thermosensor 690 provided in the fixing roll 610, and the temperature is controlled using a control unit. The thermosensor 690 is not particularly limited, and examples thereof include a thermistor, a temperature sensor and the like.

Image Forming Apparatus

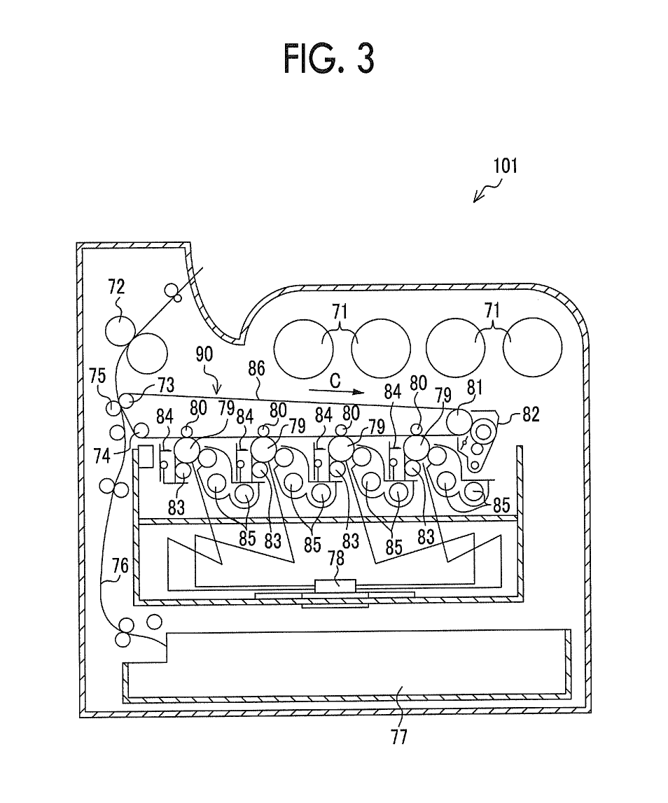

Next, an image forming apparatus for which the endless belt of the exemplary embodiment and the roll of the exemplary embodiment are used will be described. FIG. 3 is a schematic view explaining major parts of a tandem-type image forming apparatus which includes the endless belt according to the exemplary embodiment as a pressurizing belt of a fixing apparatus, the endless belt according to the exemplary embodiment as an intermediate transferring belt and the roll according to the exemplary embodiment as a fixing roll of the fixing apparatus.

Specifically, an image forming apparatus 101 is configured to include a photoreceptor 79 (electrostatic latent image-holding member), a charging roll 83 that charges a surface of the photoreceptor 79, a laser-generating apparatus 78 (electrostatic latent image forming unit) that exposes the surface of the photoreceptor 79 and forms an electrostatic latent image, a developer unit 85 (developing unit) that develops the latent image formed on the surface of the photoreceptor 79 using a developing agent and forms a toner image, an intermediate transferring belt 86 (intermediate transferring member) to which the toner image formed using the developer unit 85 is transferred from the photoreceptor 79, a first transferring roll 80 (first transferring unit) that transfers the toner image to the intermediate transferring belt 86, a photoreceptor cleaning member 84 that removes toner, dirt and the like attached to the photoreceptor 79, a second transferring roll 75 (second transferring unit) that transfers the toner image on the intermediate transferring belt 86 to a recording medium and a fixing apparatus 72 (fixing unit) that fixes the toner image on the recording medium. The first transferring roll 80 may be disposed on the photoreceptor 79 as illustrated in FIG. 3 or may be disposed at a location above the photoreceptor 79.

Furthermore, the configuration of the image forming apparatus 101 illustrated in FIG. 3 will be described in detail.

In the image forming apparatus 101, the charging roll 83, the developer unit 85, the first transferring roll 80 disposed through the intermediate transferring belt 86 and the photoreceptor cleaning member 84 are disposed around the photoreceptor 79 counterclockwise, and a set of those members forms a developing unit that corresponds to a color. In addition, each developing unit is provided with a toner cartridge 71 that refills the developer unit 85 with the developing agent, and the photoreceptor 79 in each developing unit is provided with the laser-generating apparatus 78 that radiates laser light in accordance with image information on the surface of the photoreceptor 79 on a downstream side of the charging roll 83 (in a rotating direction of the photoreceptor 79) and on an upstream side of the developer unit 85.

Four developing units corresponding to four colors (for example, cyan, magenta, yellow and black) are disposed in series in the image forming apparatus 101 in a horizontal direction, and the intermediate transferring belt 86 is provided so as to pass through transferring areas between the photoreceptors 79 and the first transferring rolls 80 in the four developing units. The intermediate transferring belt 86 is supported by a support roll 73, a support roll 74 and a driving roll 81 which are provided counterclockwise in this order on an inner surface side of the intermediate transferring belt 86, thereby forming a belt-supporting apparatus 90. Meanwhile, the four first transferring rolls are located on a downstream side of the support roll 73 (in a rotating direction of the intermediate transferring belt 86) and on an upstream side of the support roll 74. In addition, a transfer cleaning member that cleans an outer circumferential surface of the intermediate transferring belt 86 is provided on an opposite side of the driving roll 81 through the intermediate transferring belt 86 so as to come into contact with the driving roll 81.

In addition, the second transferring roll 75 for transferring the toner image formed on the outer circumferential surface of the intermediate transferring belt 86 to a surface of recording paper transported through a paper path 76 from a paper feeding portion 77 is provided on an opposite side of the support roll 73 through the intermediate transferring belt 86 so as to come into contact with the support roll 73.

In addition, the paper feeding portion 77 that stores a recording medium is provided at a bottom of the image forming apparatus 101, and the recording medium is fed from the paper feeding portion 77 through the paper path 76 so as to pass through a contact portion between the support roll 73 and the second transferring roll 75 which configures a second transferring portion. A recording medium that has passed through the contact portion is transported using a transporting unit (not shown) so as to be inserted into a contact portion in the fixing apparatus 72, and finally ejected outside the image forming apparatus 101.

Next, an image forming method using the image forming apparatus 101 illustrated in FIG. 3 will be described. A toner image is formed in each developing unit, the surface of the photoreceptor 79 rotating counterclockwise is charged using the charging roll 83, then, a latent image (electrostatic latent image) is formed on the charged surface of the photoreceptor 79 using the laser-generating apparatus 78 (exposing apparatus), subsequently, the latent image is developed using the developing agent supplied from the developer unit 85 so as to form a toner image, and the toner image conveyed to the contact portion between the first transferring roll 80 and the photoreceptor 79 is transferred to the outer circumferential surface of the intermediate transferring belt 86 rotating in an arrow C direction. Meanwhile, the photoreceptor 79 that has transferred the toner image is prepared to form the subsequent toner image after toner, dirt and the like attached to the surface of the photoreceptor are cleaned using the photoreceptor cleaning member 84.

Toner images developed in the respective developing units of the respective colors are conveyed to the second transferring portion in a state of being sequentially superimposed on the outer circumferential surface of the intermediate transferring belt 86 so as to match image information, and transferred to a surface of recording paper transported from the paper feeding portion 77 through the paper path 76 by the second transferring roll 75. Furthermore, the recording paper to which the toner image has been transferred is pressurized and heated when passing through the contact portion in the fixing apparatus 72 so as to fix the toner image, the image is formed on the surface of the recording medium, and then the recording paper is ejected outside the image forming apparatus.

Fixing Apparatus (Image-Fixing Apparatus)

FIG. 4 is a schematic configuration view of the fixing apparatus 72 provided in the image forming apparatus 101 according to the exemplary embodiment. The fixing apparatus 72 illustrated in FIG. 4 includes the fixing roll 610 which is a rotary-driven rotating member, an endless belt 620 (pressurizing belt) and a pressure pad 640 which is a pressure member that pressurizes the fixing roll 610 through the endless belt 620. Meanwhile, the pressure pad 640 simply needs to maintain the endless belt 620 and the fixing roll 610 relatively pressurized. Therefore, the endless belt 620 may be pressurized onto the fixing roll 610, or the fixing roll 610 may be pressurized onto the endless belt 620.

A halogen lamp 660 is provided in the fixing roll 610 as an example of a heating unit for heating non-fixed toner images in an insertion area. The heating unit is not limited to the halogen lamp, and other heat generation members that generate heat may be used.

Meanwhile, the thermosensor 690 is disposed in contact with the surface of the fixing roll 610. Lighting of the halogen lamp 660 is controlled based on temperature values measured by the thermosensor 690, and the surface temperature of the fixing roll 610 is maintained at a set temperature (for example, 150° C.)

The endless belt 620 is rotatably supported by the pressure pad 640 disposed inside, a belt-travelling guide 630 and an edge guide (not shown). In addition, the endless belt is disposed in contact with the fixing roll in the insertion area N in a state of being pressurized with respect to the fixing roll 610.

The pressure pad 640 is disposed in the endless belt 620 in a state of being pressurized onto the fixing roll 610 through the endless belt 620, and forms the insertion area N with the fixing roll 610. The pressure pad 640 disposes a pre-insertion member 641 for ensuring a wide insertion area N on an entrance side of the insertion area N, and disposes a peeling insertion member 642 for supplying stains to the fixing roll 610 on an exit side of the insertion area N.

Furthermore, in order to decrease sliding friction between an inner circumferential surface of the endless belt 620 and the pressure pad 640, a low-friction sheet 680 is provided on surfaces of the pre-insertion member 641 and the peeling insertion member 642 which come into contact with the endless belt 620. In addition, the pressure pad 640 and the low-friction sheet 680 are held in a metal holder 650.

Furthermore, the belt-travelling guide 630 is attached to the holder 650, and configured to allow the endless belt 620 to smoothly rotate. That is, since the belt-travelling guide 630 slides and causes friction on the inner circumferential surface of the endless belt 620, the belt-travelling guide is formed of a material having a small static friction coefficient. In addition, the belt-travelling guide 630 is formed of a material having a low thermal conductivity so as not to easily absorb heat from the endless belt 620.

In addition, the fixing roll 610 is rotated in the arrow C direction using a driving motor (not shown), and the endless belt 620 rotates in an opposite direction to the rotation direction of the fixing roll 610 in accordance with the rotation of the fixing roll. That is, the fixing roll 610 rotates clockwise in FIG. 4, but the endless belt 620 rotates counterclockwise.

Paper K with unfixed toner thereon is guided using a fixing entrance guide 560, and transported to the insertion area N. In addition, when the paper K passes through the insertion area N, the toner image on the paper K is fixed by a pressure exerting on the insertion area N and heat supplied from the fixing roll 610.

In the fixing apparatus 72, the insertion area N is ensured using the pre-insertion member 641 having a recess shape that follows the outer circumferential surface of the fixing roll 610.

In addition, the fixing apparatus 72 according to the exemplary embodiment is configured so that a strain of the fixing roll 610 is locally increased in an exit area of the insertion area N by disposing the peeling insertion member 642 on the outer circumferential surface of the fixing roll 610 in a protruding manner. The above configuration allows the paper K to peel from the fixing roll 610 after fixing.

In addition, as a peeling-assisting unit, a peeling member 700 is provided on a downstream side of the insertion area N of the fixing roll 610. The peeling member 700 is held using a holder 720 in a state in which a peeling baffle 710 is in proximity to the fixing roll 610 in a facing orientation (counter direction) to the rotation direction of the fixing roll 610.

Portable Devices

The surface protection film according to the exemplary embodiment may be used as protection films for screens that display images and the like in portable terminals (portable devices).

Regarding screens (for example, liquid crystal screens) and the like in portable terminals (portable devices) such as smartphones, portable phones and portable game machines, there are cases in which, during operation, a fingertip (nail) comes into contact with the screens, and, furthermore, in a case in which when there is a stylus, the stylus tip comes into contact with and scratches the screens, thereby causing scratches. In contrast to the above, when the surface protection film according to the exemplary embodiment is provided as a protection film, even in a case in which scratches are caused, since the scratches are repaired, the generation of permanently remaining scratches (permanent damage) on a surface is efficiently suppressed.

Window Glass and Vehicle Bodies

The surface protection film according to the exemplary embodiment may be used as protection films for window glass in buildings, vehicles and the like. In addition, the surface protection film according to the exemplary embodiment may be used as protection films for vehicle bodies.

Since there is exposure to outside environment, there are cases in which window glass in buildings, vehicle window glass, vehicle bodies and the like are scratched due to a variety of causes such as contact with sand, leaves, tree branches and the like conveyed by wind or contact with insects and the like. In contrast to the above, when the surface protection film according to the exemplary embodiment is provided as a protection film, even in a case in which scratches are caused, since the scratches are repaired, the generation of permanently remaining scratches (permanent damage) on a surface is efficiently suppressed.

Eyeglass Lenses

The surface protection film according to the exemplary embodiment may be used as protection films for eyeglass lenses.

Regarding eyeglass lenses, there are cases in which minute particles (contaminations) are attached to a surface, and the surface is rubbed using dry cloths with the minute particles thereon so as to be scratched. In contrast to the above, when the surface protection film according to the exemplary embodiment is provided as a protection film, even in a case in which scratches are caused, since the scratches are repaired, the generation of permanently remaining scratches (permanent damage) on a surface is efficiently suppressed.

Optical Discs

The surface protection film according to the exemplary embodiment may be used as protection films for recording surfaces of optical discs.

Regarding recording surfaces and the like of optical discs, such as CDs, DVDs and BDs, and the like, there are cases in which the recording surfaces are brought into contact with case edges when put into and out of a case, brought into contact with apparatus edges when put into and out of a reproduction apparatus, a recording apparatus or the like, or brought into contact with fingertips (nails), and friction with the edges and fingertips causes scratches on the recording surfaces. As a result, there are cases in which scanning errors occur due to damage caused on the recording surfaces. In contrast to the above, when the surface protection film according to the exemplary embodiment is provided as a protection film, even in a case in which scratches are caused, since the scratches are repaired, the generation of permanently remaining scratches (permanent damage) on a surface is efficiently suppressed. As a result, the occurrence of scanning errors is also efficiently suppressed.

Solar Light Panel

The surface protection film according to the exemplary embodiment may be used as protection films for reflection surfaces of solar light panels.

Since there is exposure to outside environment, there are cases in which solar cell panels or panels that reflect solar light are scratched due to a variety of causes such as contact with sand, leaves, tree branches and the like conveyed by wind or contact with insects and the like. In contrast to the above, when the surface protection film according to the exemplary embodiment is provided as a protection film, even in a case in which scratches are caused, since the scratches are repaired, the generation of permanently remaining scratches (permanent damage) on a surface is efficiently suppressed.

### EXAMPLES

Hereinafter, the invention will be described in detail using examples, but the invention is not limited to examples described below. Further, in the following description, “part” and “%” are by weight unless particularly otherwise described.

### Example 1

### Synthesis of Acrylic Resin Prepolymer A1

A monomer solution composed of
Hydroxyethyl methacrylate which is a monomer that becomes the short side chain hydroxyl group (HEMA, the number of carbon atoms in the side chain hydroxyl group: 3): 110 parts
CHEMINOX FAMAC 6 (manufactured by Unimatec Co., Ltd., 2-(perfluorohexyl) ethyl methacrylate, fluorine atom included): 122 parts
SILAPLANE FM-0721 (manufactured by Chisso Corporation, butyl (3-methacryloxypropyl) polydimethylsiloxane, silicon included): 100 parts
PLACCEL FM3 which is a monomer that becomes the long side chain hydroxyl group (manufactured by Daicel Corporation, lactone-denatured methacrylate, the number of carbon atoms in the side chain hydroxyl group: 21): 267 parts
Polymerization initiator (benzoyl peroxide, BPO): 27 parts
Butyl acetate: 60 parts

is put into a dropping funnel, added dropwise over 3 hours to butyl acetate (300 parts) heated to 110° C. in a nitrogen reflux under stirring, and polymerized. Furthermore, a liquid composed of butyl acetate (135 parts) and BPO (3 parts) is added dropwise over 1 hour, and a reaction is completed. Further, during the reaction, the temperature is held at 110° C. at all times, and stirring is continued. An acrylic resin prepolymer A1 including the long side chain hydroxyl group is synthesized in the above manner.

Synthesis of Block-Type Isocyanate C1

Methyl ethyl ketoxime (MEKOX, 66 parts) is added dropwise under water cooling to a liquid mixture composed of
DURANATE D201 manufactured by Asahi Kasei Chemicals Corporation (compound name: a difunctional-type of hexamethylene diisocyanate): 200 parts
Methyl ethyl ketone: 60 parts, and

stirred over 24 hours, thereby making isocyanate blocked, and a block-type isocynate C1 liquid is obtained.

Formation of Sample Protection Film A1

The following B liquid and the following C liquid are added to the following A liquid at the following ratio, and a dispersion treatment is carried out for 50 hours under a condition of rotation rate: 150 rpm using a dispersion apparatus (manufactured by Asahi Rika Seisakusho, K.K., product name: AV-1-type ball mill rotation stand, 2 mm φ zirconia beads).

A liquid mixture for forming a protection film obtained in the above manner is cast on a base material (polyimide film, manufactured by Du Pont-Toray Co., Ltd., product name: KAPTON film H300, film thickness: 75 μm), cured at 85° C. for 1 hour and, furthermore, at 180° C. for 1 hour, thereby obtaining a sample protection film A1 having a film thickness of 40 μm.
A liquid (liquid of the above acrylic resin prepolymer A1, 46.3%, hydroxyl value: 132): 151 parts
B liquid (filler dispersion liquid, carbon black particles, manufactured by Degussa-Huls AG, product name: PrintexU, primary particle diameter: 25 nm, solvent: butyl acetate, filler concentration: 6.7% by weight, filler concentration with respect to the entire solid content: 20% by weight): 383 parts
C liquid (liquid of the above block-type isocyanate C1, 82% by weight): 71 parts

The measurement results of the average primary particle diameter and average secondary particle diameter of the filler, the surface roughness Ra, surface roughness Rz and Martens' hardness of the sample protection film are described in Table 1.

### Example 2

A sample protection film A2 is obtained using the method described in Example 1 except that the B liquid and the C liquid are added to the A liquid, and the dispersion condition is changed to for 10 days under a condition of rotation rate: 150 rpm.

### Example 3

A sample protection film A3 is obtained using the method described in Example 1 except that the solvents used for the A liquid (acrylic resin prepolymer) and the B liquid (filler dispersion liquid) are both changed from butyl acetate to methyl ethyl ketone.

### Example 4

A sample protection film A4 is obtained using the method described in Example 3 except that the carbon black particles used for the B liquid (filler dispersion liquid) is changed to Special Black 100 (product name, manufactured by Degussa-Huls AG, primary particle diameter: 50 nm).

### Example 5

### Synthesis of Acrylic Resin Prepolymer A2

A monomer solution composed of
Hydroxyethyl methacrylate which is a monomer that becomes the short side chain hydroxyl group (HEMA, the number of carbon atoms in the side chain hydroxyl group:3): 84 parts
CHEMINOX FAMAC 6 (manufactured by Unimatec Co., Ltd., 2-(perfluorohexyl)ethyl methacrylate, fluorine atom included): 111 parts
SILAPLANE FM-0721 (manufactured by Chisso Corporation, butyl(3-methacryloxypropyl)polydimethylsiloxane, silicon included): 100 parts
PLACCEL FM3 which is a monomer that becomes the long side chain hydroxyl group (manufactured by Daicel Corporation, lactone-denatured methacrylate, the number of carbon atoms in the side chain hydroxyl group: 21): 305 parts
Polymerization initiator (benzoyl peroxide, BPO): 27 parts
Butyl acetate: 60 parts

is put into a dropping funnel, added dropwise over 3 hours to butyl acetate (300 parts) heated to 110° C. in a nitrogen reflux under stirring, and polymerized. Furthermore, a liquid composed of butyl acetate (135 parts) and BPO (3 parts) is added dropwise over 1 hour, and a reaction is completed. Further, during the reaction, the temperature is held at 110° C. at all times, and stirring is continued. An acrylic resin prepolymer A2 including the long side chain hydroxyl group is synthesized in the above manner.

Formation of Sample Protection Film A5

The following B material is added to the following A liquid at the following ratio, a dispersion treatment is carried out for 15 minutes under condition of power: 6 and tuning: 5 using a dispersion apparatus (manufactured by Nissei Corporation, product name: ultrasonic homogenizer US-300 TCVP), and the following C liquid is added and the resultant is stirred.

A liquid mixture for forming a protection film obtained in the above manner is cast on a base material (polyimide film, manufactured by Du Pont-Toray Co., Ltd., product name: KAPTON film H300, film thickness: 75 μm), cured at 85° C. for 1 hour and, furthermore, at 180° C. for 1 hour, thereby obtaining a sample protection film A5 having a film thickness of 40 μm.
A liquid (liquid of the above acrylic resin prepolymer A2, 47.5%, hydroxyl value: 144): 105 parts
B material (filler, low-molecular weight polytetrafluoroethylene (PTFE) particles, manufactured by Daikin Industries, Ltd., product name: LUBRON L2, filler concentration with respect to the entire solid content: 10% by weight): 5 parts
C liquid (DURANATE TPA-B80E manufactured by Asahi Kasei Chemicals Corporation, compound name: an isocyanurate-type blocked hexamethylene diisocyanate, 80% by weight): 52 parts

### Example 6

A sample protection film A6 is obtained using the method described in Example 5 except that a dispersion liquid is used as the B material (filler) by adding a butyl acetate solution (30 parts) including a surfactant (GF-400 manufactured by Toagosei Co. Ltd., 0.5% by weight) for an alkyl fluoride group-containing copolymer to the low-molecular-weight PTFE particles in advance and carrying out a dispersion treatment for 5 minutes using an ultrasonic washer (2510J-MT manufactured by Yamato Scientific Co., Ltd.), then, the A liquid and the C liquid are added, and stirred under the conditions described in Example 5.

### Comparative Example 1

No protection film is formed, the surface roughness Ra, surface roughness Rz and Martens' hardness of the base material (polyimide film) are measured, and evaluation tests described below are carried out.

### Comparative Example 2

A sample protection film B2 is obtained using the method described in Example 1 except that the B liquid (filler dispersion liquid) is not added, and the A liquid and the C liquid are mixed and then defoamed under reduced-pressure for 10 minutes.

### Comparative Example 3

A sample protection film B3 is obtained using the method described in Example 5 except that the B material (filler) is not added, and the A liquid and the C liquid are mixed and then defoamed under reduced-pressure for 10 minutes.

Evaluation

Tests are carried out on the self-repairing property, static contact angle and friction coefficient of the sample protection films (base material in Comparative Example 1) formed in Examples and Comparative Examples using the following methods.

Self-Repairing Property (Measurement of the Rate of Return)

The rate of return is measured using the method described above. The measurement results are described in Table 1.

Measurement of the Static Contact Angle

The static contact angle with respect to water is measured using a contact angle meter (manufactured by Kyowa Interface Science Co., Ltd., model No.: CA-S). Further, the measurement conditions are in accordance with a θ/2 method at 20° C.

Measurement of the Friction Coefficient

The static friction coefficient and dynamic friction coefficient are measured using a friction coefficient measuring apparatus (manufactured by Shinto Scientific Co., Ltd., product name: variable normal load friction and wear measurement system HEIDON TRIBOGEAR HHS2000). Further, the measurement conditions are a temperature: room temperature (20° C.) and use of a constant load reciprocal friction measurement mode, and static friction resistance and dynamic friction resistance in a scanning direction applied to a scratching needle (made of sapphire, tip radius r=0.3 mm) are measured when the scratching needle is reciprocated 10 mm on the surface of a transparent protection film once at a speed of 1 mm/sec while applying a vertical load of 10 g, and thereby a static friction coefficient and a dynamic friction coefficient are calculated.

TABLE 1

| | Filler | | | | | Evaluation | | | |
|---|---|---|---|---|---|---|---|---|---|
| | Average primary | Average secondary | Surface roughness | | Martens' | Rate of | Contact | Static | Dynamic |
| | particle diameter | particle diameter | Ra | Rz | hardness | return | angle | friction | friction |
| | [nm] | [μm] | [μm] | [μm] | [N/mm²] | [%] | [degree] | coefficient | coefficient |
| Example 1 | 25 nm | 1 μm | 0.13 | 0.71 | 27.6 | 84.99 | 109 | 0.63 | 0.22 |
| Example 2 | 25 nm | 0.8 μm | 0.10 | 0.49 | 5.8 | 84.5 | 109 | 0.88 | 0.16 |
| Example 3 | 25 nm | 3 μm | 0.20 | 0.88 | 3.9 | 97.06 | 109 | 0.63 | 0.24 |
| Example 4 | 50 nm | 5 μm | 0.35 | 1.12 | 3.5 | 95.24 | 109 | 0.44 | 0.21 |
| Example 5 | 3 μm | 5 μm to 10 μm | 0.06 | 0.23 | 27.7 | 85.2 | 102 | 0.55 | 0.52 |
| Example 6 | 3 μm | 10 μm to 20 μm | 0.12 | 0.41 | 26.0 | 86.1 | 102 | 0.16 | 0.15 |
| Comparative | — | — | 0.03 | 0.18 | 263.0 | 75.88 | 90 | 0.45 | 0.43 |
| Example 1 | | | | | | | | | |
| Comparative | — | — | 0.04 | 0.16 | 0.9 | 92.24 | 108 | 1.57 | 1.38 |
| Example 2 | | | | | | | | | |
| Comparative | — | — | 0.04 | 0.21 | 30.7 | 85.5 | 102 | 0.97 | 0.85 |
| Example 3 | | | | | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A surface protection film comprising:
a urethane resin formed by polymerizing an acrylic resin having a hydroxyl group at a side chain and an isocyanate,
wherein a Martens' hardness is 50 N/mm² or less, and a surface roughness Ra measured based on JIS-B0601 is 0.05 μm to 1.0 μm.

2. The surface protection film according to claim 1, comprising:
a filler.

3. The surface protection film according to claim 2,
wherein the filler is a filler selected from the group consisting of carbon black particles, fluororesin particles, polyethylene particles, acrylic particles, polystyrene particles, urethane particles, polyamide particles, polyimide particles and polyester particles.

4. The surface protection film according to claim 2,
wherein the filler is a filler selected from the group consisting of metal oxide particles, metal particles and metal salt particles.

5. The surface protection film according to claim 2,
wherein an average primary particle diameter of the filler is 0.01 μm to 10 μm.

6. The surface protection film according to claim 2,
wherein an average primary particle diameter of the filler is 0.01 μm to 5 μm.

7. The surface protection film according to claim 2,
wherein an average primary particle diameter of the filler is 0.02 μm to 1 μm.

8. The surface protection film according to claim 2,
wherein an average secondary particle diameter of the filler is 0.1 μm to 50 μm.

9. The surface protection film according to claim 2,
wherein an average secondary particle diameter of the filler is 0.1 μm to 30 μm.

10. The surface protection film according to claim 2,
wherein an average secondary particle diameter of the filler is 0.3 μm to 5 μm.

11. The surface protection film according to claim 1,
wherein the acrylic resin having a hydroxyl group contains a fluorine atom by polymerization of monomers having a hydroxyl group and monomers having a fluorine atom.

12. The surface protection film according to claim 11,
wherein a content ratio of monomers having a fluorine atom to all monomers that constitute the acrylic resin is 0.1% by weight to 50% by weight.

13. The surface protection film according to claim 11,
wherein a content ratio of monomers having a fluorine atom to all monomers that constitute the acrylic resin is 1% by weight to 25% by weight.

14. The surface protection film according to claim 11,
wherein a content ratio of monomers having a fluorine atom to all monomers that constitute the acrylic resin is 1% by weight to 10% by weight.

15. The surface protection film according to claim 1, wherein the surface roughness Ra is 0.05 μm to 0.5 μm.

16. The surface protection film according to claim 1, wherein the surface roughness Ra is 0.05 μm to 0.3 μm.

17. The surface protection film according to claim 1, wherein the Martens' hardness is from 0.01 N/mm² to 50 N/mm².

18. The surface protection film according to claim 1, wherein the Martens' hardness is from 0.1 N/mm² to 30 N/mm².

19. The surface protection film according to claim 1, wherein the Martens' hardness is from 0.5 N/mm² to 20 N/mm².
